(19) United States
(12) Patent Application Publication
(10) Pub. No.: US 2017/0073619 A1
(43) Pub. Date: Mar. 16, 2017

(54) Dishwashing Composition

(71) Applicant: NOVOZYMES A/S, Bagsvaerd (DK)

(72) Inventor: Jan Peter Skagerlind, Hellsingborg (SE)

(73) Assignee: Novozymes A/S, Bagsvaerd (DK)

(21) Appl. No.: 15/123,290

(22) PCT Filed: Mar. 25, 2015
(86) PCT No.: PCT/EP2015/056449

§ 371 Date: Sep. 2, 2016

(30) Foreign Application Priority Data
Mar. 25, 2014 (EP) 14161549.2

(51) Int. Cl. C11D 3/386; C11D 11/00; C11D 1/66; C11D 3/33

(52) U.S. Cl. CPC C11D 3/38627; C11D 3/33; C11D 11/0023; C11D 1/66

(57) ABSTRACT

The present invention concerns an automated dishwashing method comprising the steps of exposing dishware to an aqueous wash liquor comprising at least one lipase and a strong sequestering builder; completing at least one wash cycle; and optionally rinsing and drying the dishware; wherein the strong sequestering builder is a non-phosphorus builder. The invention further concerns an ADW detergent composition comprising lipase, a strong sequestering builder, use of the ADW composition and a rinse aid.

### REFERENCE TO A SEQUENCE LISTING

This application contains a Sequence Listing in computer readable form, which is incorporated herein by reference.

### FIELD OF THE INVENTION

The present invention concerns an automated dishwashing method comprising the steps of exposing dishware to an aqueous wash liquor comprising at least one lipase and a strong sequestering builder; completing at least one wash cycle; and optionally rinsing and drying the dishware; wherein the strong sequestering builder is a non-phosphorus builder.

The invention further concerns an ADW detergent composition comprising lipase, use of the ADW composition and an acidic rinse aid.

### BACKGROUND OF THE INVENTION

Hard water is water that has high mineral content. Water's hardness is determined by the concentration of multivalent cations in the water. Multivalent cations are cations (positively charged metal complexes) with a charge greater than 1+. Usually, the cations have the charge of 2+. Common cations found in hard water include Ca²⁺ and Mg²⁺. Rainwater and distilled water are soft, because they contain few ions.

One problem often associated with hard water is the built up of scale. Scale is composed mainly of calcium carbonate (CaCO₃) and magnesium carbonate (MgCO₃), magnesium hydroxide (Mg(OH)₂), calcium sulfate (CaSO₄) and other carbonates. Calcium and magnesium carbonates tend to be deposited as off-white solids on the inside surfaces of machinery. The resulting build-up of scale restricts the flow of water in pipes, heat exchangers and the like. In heat exchangers, the deposits impair the flow of heat into water, thereby reducing the heating efficiency and as a consequence hereof increased energy consumption.

More than 85% of the American homes have hard water and most households in the northern part of Europe are supplied with hard water.

U.S. Pat. No. 5,851,973 discloses a manual dishwashing composition comprising a surfactant, calcium or magnesium ions, amylase enzymes, lipase enzymes and polycarboxylic polymer thickeners.

Rahman et al. disclose the use of lipase in an automatic dishwashing detergent composition (J Surfact. Deterg. (2013) 16: 427-434).

Automatic dishwashing detergents have improved over time, but still some of the consumer needs are unmet in terms of both cleaning and finishing. In recent years, there has been an ever increasing trend towards safer and environmentally friendly detergent compositions. This trend imposes additional constrains onto the automatic dishwashing formulator. In terms of energy efficiency and raw material savings, it is desirable to design products which provide good performance even at low temperatures and with a reduction on the amount of chemicals, in particular non-readily biodegradable chemicals.

### SUMMARY OF THE INVENTION

The present invention concerns an automated dishwashing method comprising the following steps:

a. Exposing dishware to an aqueous wash liquor comprising at least one lipase and a strong sequestering builder;

b. completing at least one wash cycle; and

c. optionally rinsing and drying the dishware;

wherein the strong sequestering builder is a non-phosphorus builder. The invention further concerns an ADW composition comprising lipase and a strong sequestering builder and the use of lipase for cleaning the interior of a washing machine.

Further is claimed a rinsing aid for use in ADW.

### BRIEF DESCRIPTION OF THE FIGURES

FIG. 1 shows the temperature during the ADW wash.

### DEFINITIONS

The term automatic dishwashing detergent composition refers to compositions comprising detergent components, which composition is intended for cleaning dishware such as plates, cups, glasses, bowls, cutlery such as spoons, knives, forks, serving utensils, ceramics, plastics, metals, china, glass and acrylics in a dishwashing machine. The terms encompass any materials/compounds selected for domestic or industrial washing applications and the form of the product can be liquid, powder or granulate. In addition to lipase, the automatic dishwashing detergent composition contains detergent components such as polymers, bleaching systems, bleach activators, bleach catalysts, silicates, dyestuff and metal care agents.

Detergent components: the term “detergent components” is defined herein to mean the types of chemicals which can be used in detergent compositions for automatic dishwashing. Examples of detergent components are polymers, bleaching systems, bleach activators, bleach catalysts, silicates, dyestuff and metal care agents.

Dishware: The term dish ware is intended to mean any form of kitchen utensil, dinner set or tableware such as but not limited to pans, plates, cops, knives, forks, spoons, porcelain etc.

Fatty acid precipitate means precipitate formed by fatty acids, monoglycerides, diglycerides and cations which precipitate also comprises other types of soil included in the fatty acid precipitate. The free fatty acids can react with components present in the wash liquor, e.g. cations such as calcium ions and Magnesium ions. This precipitate can bind other kinds of soil present in the wash liquor, for example dirt which have been removed from the dishware and/or interior of the dishwashing machine during the wash cycle. The fatty acid precipitate is seen as a slippery greasy white, yellow or grey precipitate, which may have an unpleasant odor.

Improved wash performance: The term “improved wash performance” is defined herein as an automatic dishwashing detergent composition displaying an increased wash performance relative to the wash performance of a similar automatic dishwashing detergent composition without a lipase, e.g. by increased soil removal.

Sequence identity: The relatedness between two amino acid sequences or between two nucleotide sequences is described by the parameter “sequence identity

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment).

Soft water is defined as water having a degree of hardness below 3° dH, whereas moderately hard water has a degree of hardness in the range of 3 to 6.75° dH. Hard water has a degree of hardness in the range of 6.76 to 10° dH. Very hard water has a degree of hardness above 10° dH.

Variant: The term “variant” means a polypeptide having enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash cycle: The term “wash cycle” is defined herein as a washing operation wherein dishware are exposed to the wash liquor for a period of time by circulating the wash liquor and spraying the wash liquor onto the dishware in order to clean the dishware and finally the superfluous wash liquor is removed. A wash cycle may be repeated one, two, three, four, five or even six times at the same or at different temperatures. Hereafter the dishware is generally rinsed and dried. One of the wash cycles can be a soaking step, where the dishware is left soaking in the wash liquor for a period.

Wash liquor: The term “wash liquor” is defined herein as the solution or mixture of water and detergent components optionally including a lipase.

Wash performance: The term “wash performance” is defined herein as the ability of an automatic dishwashing detergent composition to remove soil present on dishware to be cleaned during washing. The wash performance may be measured by inspecting the washed dishware, light reflectance (460 nm) or by measuring weight, how much of the soil has been removed. This can be done by measuring the difference in weight on plates, tiles or similar.

Wash time: The term “wash time” is defined herein as the time it takes for the entire washing process; i.e. the time for the wash cycle(s) and rinse cycle(s) together.

In describing the variants of the present invention, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases, the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple alterations. Variants comprising multiple alterations are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants:
“Tyr167Gly+Arg170Gly”, “Tyr167Gly+Arg170Ala”, “Tyr167Ala+Arg170Gly”, and “Tyr167Ala+Arg170Ala”.

### DETAILED DESCRIPTION OF THE INVENTION

Enzymes as amylase and protease are commonly used in automatic dish washing (ADW). However the use of lipase in ADW has been omitted because of the disadvantages the lipase cause. Use of lipase in ADW leaves the washed dishware and the interior of the dishwasher with a dirty, greasy, slippery and soiled appearance, which is undesirable for the consumer. When opening the dishwashing machine after the completion of a wash, the consumer may further be met with an unattractive and unpleasant odour leaving the consumer with the impression that the dishware is not completely clean. That is why lipase is presently not comprised in commercially available detergent compositions for ADW.

The inventor has surprisingly found that by lowering the hardness of the water used in a washing process with lipase, the dishware and the interior of the dishwasher is left clean and attractive without any soil deposits or fatty acid precipitate and without any malodor. The dishware and the interior of the washing machine is shining and clean and satisfies the consumers need for cleaning dishware.

In addition, safe and environmentally friendly detergent compositions are of utmost importance for consumers. The consumer wants products which provide good performance even at low temperatures and with a reduction on the amount of chemicals, in particular chemicals such as phosphorus compounds which contribute to pollution of the environment.

The invention concerns an automated dishwashing method comprising the following steps:
a. Exposing dishware to an aqueous wash liquor comprising at least one lipase and a strong sequestering builder;
b. Completing at least one wash cycle; and
c. Optionally rinsing and drying the dishware;

wherein the strong sequestering builder is selected from the group consisting of EDTA, MGDA, NTA, IDS, GLDA and EDDS.

The invention concerns automated dishwashing method comprising the following steps:
a. Exposing dishware to an aqueous wash liquor comprising at least one lipase and a builder selected from the group consisting of: EDTA, MGDA, NTA, IDS, GLDA and EDDS;
b. Completing at least one wash cycle; and
c. Optionally rinsing and drying the dishware;

wherein the strong sequestering builder is selected from the group consisting of.The invention further concerns an automatic dishwashing detergent composition comprising at least one lipase and a strong sequestering builder, wherein the strong sequestering builder is selected from the group consisting of EDTA, MGDA, NTA, IDS, GLDA and EDDS. The strong sequestering builder ensures that the hardness of the water is lowered, e.g. below 3° dH, and the particular strong sequestering builders are environmental friendly in addition to lowering the water hardness because they in comparison to other strong sequestering builders do not comprise phosphate.

Lipase acts on fats and therefore facilitates the cleaning of dishware soiled with fatty material. In order to clean fatty material from dishware the wash liquor needs to have a high temperature, e.g. a temperature above the melting point of the fatty material. By the use of lipase in the dishwashing process, it is therefore possible to clean away fatty material at a lower temperature and thereby save energy for heating the water. The time period for completing a wash cycle may even be shortened, as the use of lipase improves the release and removal of fatty soil.

The degree of hardness of the wash liquor may be below 2.9° dH, such as below 2.8° dH, below 2.7° dH, below 2.6° dH, below 2.5° dH, below 2.4° dH, below 2.3° dH, below 2.2° dH, below 2.1° dH, below 2.0° dH, below 1.9° dH, below 1.8° dH, below 1.7° dH, below 1.6° dH, below 1.5° dH, below 1.4° dH, below 1.3° dH, below 1.2° dH, below 1.1° dH, below 1.0° dH, below 0.9° dH, below 0.8° dH, below 0.7° dH, below 0.6° dH, below 0.5° dH, below 0.4° dH, below 0.3° dH, below 0.2° dH or below 0.1° dH.

One way of obtaining a low degree of hardness in the wash liquor is by using distilled water, rain water or softened water in the ADW method. Use of rain water in ADW is advantageous to the environment, as the limited resources of ground water can be saved for other purposes.

The use of the inventive ADW detergent composition or the inventive automated dishwashing method releases and removes fatty soil from the dishware during an automatic dishwashing process and ensures that no fatty acid precipitate is build up during the dishwashing process. Furthermore the use of lipase in ADW will remove any fatty acid precipitate left from a previous wash. The fatty acid precipitate has a slippery, greasy and dirty appearance and sticks to the dishware and the interior of the dishwashing machine. Especially the filter in the drain of a dishwashing machine may be covered with fatty acid precipitate.

The concentration of the strong sequestering builder in the ADW detergent composition may be above 2 gram strong sequestering builder/wash cycle (g/w), such as in the range of 3-100 g/w

The concentration of the strong sequestering builder in the ADW detergent composition may be above 16.2 gram of the strong sequestering builder/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.

The concentration of the strong sequestering builder in the wash liquor may be above 3 gram of the strong sequestering builder/liter of wash liquor (g/L), such as in the range of 3-30 g/L, in the range of 4-30 g/L, in the range of 5-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 8-30 g/L, in the range of 9-30 g/L, in the range of 10-30 g/L, in the range of 15-30 g/L or in the range of 20-30 g/L.

The concentration of EDTA in the ADW detergent composition may be above 16.2 gram EDTA/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.

The concentration of EDTA in the wash liquor may be above 3 gram EDTA/liter of wash liquor (g/L), such as in the range of 3-30 g/L, in the range of 4-30 g/L, in the range of 5-30 g/L, in the range of 6-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 7-30 g/L, in the range of 8-30 g/L, in the range of 9-30 g/L, in the range of 10-30 g/L, in the range of 15-30 g/L or in the range of 20-30 g/L.The EDTA should be present in wash liquor in the same wash cycle as the lipase, such as the main wash.

The automated dishwashing method or the ADW detergent composition may comprise the use of a surfactant or a blend of two or more surfactants in the wash liquor. The surfactant lowers the surface tension between the wash liquor and the dishware and thereby allows the dishware to be cleaned even more effectively. The surfactant may be a non-ionic surfactant. The non-ionic surfactant works together with the lipase in cleaning the dishware and the interior of the dishwashing machine. The dishware and the interior of the dishwasher is therefore effectively cleaned and no dirty or greasy deposits are left in the dishwasher. Examples of especially preferred non-ionic surfactants are of ethoxylated non-ionic surfactant, epoxy-capped poly(oxyalkylated) alcohols. These surfactants are low-foaming which is advantageous in ADW.

Surfactants belonging to the group of alkyl polyglucosides should be avoided in ADW as they form too much foam during the washing process. This is a problem when circulating the wash liquor in the washing machine and when removing the wash liquor when completing a wash cycle.

The effectiveness of the ADW method and the ADW detergent composition may be further improved by the use of other enzymes in addition to lipase. Commonly used enzymes in ADW are amylase and protease. These enzymes are described in details below.

The present ADW method and ADW detergent composition ensures that the dishware is clean and attractive after being washed. One advantage of the present invention is that the consumer needs not rinse the dishware before washing in the dishwashing machine. The consumer is satisfied with the washing result even without pre-rinsing the dishware manually with water or even by scrubbing with water. This has the advantage that water for pre-rinsing is saved.

Further, when the consumer is satisfied with the result of the automatic washing process with the present ADW detergent composition and with the fact that no unpleasant smell is released from the clean dishware or the interior of the dishwasher, the consumer do not tend to overdose the ADW detergent composition in order to improve the cleaning result. This has a positive influence on the local environment where the drained wash liquor is released.

The hardness of the wash liquor should be 3° dH or below. One way of obtaining a low degree of hardness in the wash liquor is by using a strong sequestering builder. The strong sequestering builder should be used in an amount suitable for lowering the hardness of the wash liquor below 3° dH. The strong sequestering builder can be comprised in the ADW detergent composition of the invention.

A strong builder is classified as high efficiency chelators that can bind the divalent cations such as Ca²⁺ strongly with a logarithmic stability constant of the cation/chelator complex of above 4, particular above 5, above 6 or above 7. The stability constants are determined at an ionic strength of 0.1 M and at a temperature of 25° C.

Strong sequestering builders include for example, such materials as water-soluble tripolyphosphate, ethylene diamine tetraacetate, and organic phosphonates. Alkali metal pyrophosphates are also classed as strong sequestering builders.Strong sequestering builder are phosphorus-containing builder or non-phosphorus builder. In the present invention only non-phosphorus builders is used.

A phosphorus-containing builder generally comprises an inorganic phosphate or a phosphonate, typically an alkali metal salt such as sodium or potassium.

The inorganic phosphate may be a diphosphate, a triphosphate, a tripolyphosphate or pyrophosphate. Specific examples of inorganic phosphates include Na₅P₃O₁₀ (STPP or sodium tripolyphosphate) and Na₄P₂O₇ (tetrasodium pyrophosphate).

The phosphonate may be an alkyl phosphonate, an aryl phosphonate or an alkaryl phosphonate, wherein the alkyl, aryl or alkaryl group may be substituted. Examples of phosphonates include 1-Hydroxy Ethylidene-1,1-Diphosphonic Acid (HEDP, etidronic acid), Diethylenetriamine Penta(Methylene Phosphonic acid) (DTPMP), Ethylene diamine tetra(methylene phosphonic acid) (EDTMPA), amino tris(methylenephosphonic acid) (ATMP), Nitrilo trimethylene phosphonic acid (NTMP),2-Amino ethyl phosphonic acid (AEPn), Dimethyl methylphosphonate (DMMP),Tetramethylene diamine tetra(methylene phosphonic acid) (TDTMP), Hexamethylene diamine tetra(methylene phosphonic acid) (HDTMP), Phosphonobutane-tricarboxylic acid (PBTC), N-(phosphonomethyl) iminodiacetic acid (PMIDA), 2-carboxyethyl phosphonic acid (CEPA), 2-Hydroxy phosphonocarboxylic acid (HPAA) and.

A non-phosphorus strong sequestering builder may include for example Ethylenediaminetetraacetic acid (EDTA), methylglycinediacetic acid (MGDA), Nitrilotriacetic acid (NTA), iminodisuccinic acid (IDS), ethylenediaminedisuccinic acid (EDDS), and L-glutamic acid N,N-diacetic acid tetra sodium salt (GLDA). These non-phosphorus strong sequestering builders are used in the present invention.

Examples of stability constants on the builder calcium complex and content of phosphate are listed below:

| | | | |
|---|---|---|---|
| Builder | Builder type | Phosphorus | Log K_{Ca} |

Strong sequestering builders

| | | | |
|---|---|---|---|
| EDTA | Sequestering | no | 10.7 |
| EDTMP | Sequestering | yes | 10.0 |
| NTMP | Sequestering | yes | 7.6 |
| DTPMP | Sequestering | yes | 7.1 |
| MGDA | Sequestering | no | 7 |
| NTA | Sequestering | no | 6.4 |
| HEDP | Sequestering | yes | 6 |
| STPP | Sequestering | yes | 5.36 |
| IDS | Sequestering | no | 5.2 |
| GLDA | Sequestering | no | 5.2 |
| Pyrophosphate | Sequestering | yes | 5 |
| EDDS | Sequestering | no | 4.6 |

Other builder

| | | | |
|---|---|---|---|
| Carbonate | Precipitating | no | 7.8 |
| Citric acid | Sequestering | no | 3.5 |
| AMP | Sequestering | yes | 1.7 |

The concentration of the strong sequestering builder in the ADW detergent composition may be above 16.2 gram of the strong sequestering builder/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.

The concentration of the strong sequestering builder in the wash liquor may be above 3 gram of the strong sequestering builder/liter of wash liquor (g/L), such as in the range of 3-30 g/L, in the range of 4-30 g/L, in the range of 5-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 8-30 g/L, in the range of 9-30 g/L, in the range of 10-30 g/L, in the range of 15-30 g/L or in the range of 20-30 g/L.

The concentration of EDTA in the ADW detergent composition may be above 16.2 gram EDTA/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.

The concentration of EDTA in the wash liquor may be above 3 gram EDTA/liter of wash liquor (g/L), such as in the range of 3-30 g/L, in the range of 4-30 g/L, in the range of 5-30 g/L, in the range of 6-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 7-30 g/L, in the range of 8-30 g/L, in the range of 9-30 g/L, in the range of 10-30 g/L, in the range of 15-30 g/L or in the range of 20-30 g/L.

The EDTA should be present in wash liquor in the same wash cycle as the lipase, such as the main wash.

In addition to the strong sequestering builder, the ADW detergent composition may optionally comprise one or more other builders, e.g.a weak builder or a precipitating builder. Precipitating builders are materials such as carbonates, bicarbonates, sesquicarbonates, silicates, aluminates, oxylates, and fatty acids, particularly as an alkali metal salt such as sodium or potassium

Examples of optional builders include sodium citrate, citric acid, alcanol amines such as Mono- di- or Triethanol amine (MEA, DEA or TEA), sodium carbonate (precipitating, log K_{Ca}=7.8), sodium bicarbonate and Amino-tris-(methylene-phosphonic acid) (AMP).

During or after completion of a wash cycle the dishware can be rinsed with water or with water comprising a rinsing aid. The effectiveness of the cleaning can be even further improved if an acidic rinsing aid is used. The rinsing aid should be capable of lowering the pH below 4 during at least a period of the rinsing step. The pH may be even further lowered e.g. to below pH 3.5, such as below pH 3, below pH 2.5 or below pH 2. The period of lowering the pH may be at least 1 minute, such as at least 2 minutes, at least 3 minutes, at least 4 minutes, at least 5 minutes, at least 6 minutes or at least 7 minutes. The period of lowering the pH may even be as long as the time period for the full rinsing step.

The rinsing aid can further comprise a lipase and a strong sequestering builder.

The ability of lowering the pH during the rinsing step is due to a buffering agent.A buffer with strong buffer capacity at low pH, from pH 4 and below should be selected. The buffer capacity should correspond to the same effect as the pH drop was done with 15 ml 4M HCL/rinse cycle. The ability of lowering the pH during the rinsing step is due to a buffering agent selected from the group consisting of citric acid, acetic acid, potassium dihydrogen phosphate, boric acid, diethyl barbituric acid, Carmody buffer and Britton-Robinson buffer.

The rinsing aid can further improve the cleaning of the dishware by rinsing away any soil released from the dishware during the washing cycle. In addition, the acidic rinsing aid prevents precipitation of calcium on the dishware.

The lipase used in the ADW method can be of bacterial or fungal origin. The lipase may be chemically modified or protein engeneered. The lipase can be derived from Thermomyces, e.g. from T. lanuginosus, cutinase from Humicola, e.g. H. insolens, strains of Pseudomonas, e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, Thermobifida fusca, Geobacillus stearothermophilus, Bacillus subtilis, Streptomyces griseus and S. pristinaespiralis.

In one embodiment of the invention, the lipase has at least 90%, such as at least 95%, sequence identity to SEQ ID NO: 1 or a variant thereof.

The lipase may be a variant of SEQ ID NO: 1 selected from the group consisting of:
a) A variant of SEQ ID NO: 1 comprising the following substitutions T231R and N233R;
b) A variant of SEQ ID NO: 1 comprising the following substitutions D27R, G38A, D96E, D111A, G163K, T231 R, N233R, D254S and P256T;
c) A variant of SEQ ID NO: 1 comprising one of the following combinations of substitutions:
   a. G91A +D96G +T231 R +N233R;
   b. G91Q +T143A +E210Q +T231R +N233R +P250R;
   c. G91Q +A150G +E210Q +T231R +N233R +P250R;
   d. T37R +N39R +G91A +D96G +T231 R +N233R;
   e. G91A +D96G +G225R +T231 R +N233R;
   f. G91Q +E210Q +T231R +N233R +P250R;
   g. G91N +E210Q +T231R +N233R +P250R;
   h. G91I +E210Q +T231R +N233R +P250R;
   i. G91L +E210Q +T231R +N233R; or
   j. G91A +D96G +A150G +T231 R +N233R;
d) A variant of SEQ ID NO: 1 comprising the following substitutions Q4V+S58A+V60S+S83T+186V+A150G+E210K+L227G+T231R+N233R+P256 K.
e) A variant of SEQ ID NO: 1 comprising the following substitutions G91A,

D96W, E99K, P256V, G263Q, L264A, 1265T, G266D, T267A, L269N, 270A, 271G, 272G, 273F, (+274S).

The ADW detergent composition can be in the form of a powder, a bar, a homogenous tablet, a tablet having two or more layers, a pouch having one or more compartments, a regular or compact powder, a granule, a paste, a gel, or a regular, compact or concentrated liquid. For example the ADW detergent composition can be in the form as a ready to use tablet comprising the lipase, strong sequestering builder and other detergent components in desired concentrations.

The ADW wash liquor can comprise:

| | | |
|---|---|---|
| Lipase: | 0.01-2.0 | g/L wash liquor |
| strong sequestering builder: | 3-30 | g/L wash liquor |
| non ionic surfactant: | 0.1-1.0 | g/L wash liquor |
| Builder: | 0.5-2.0 | g/L wash liquor |
| Amylase: | 0.01-2.0 | g/L wash liquor |
| Protease: | 0.01-2.0 | g/L wash liquor |
| Bleach system: | 0.5-3.0 | g/L wash liquor |
| Silicates: | 0.0-0.5 | g/L wash liquor |

In one embodiment the ADW wash liquor ocmprises

| | | |
|---|---|---|
| Lipase: | 0.5-1.5 | g/L wash liquor |
| strong sequestering builder: | 6-15 | g/L wash liquor |
| non ionic surfactant: | 0.1-1.0 | g/L wash liquor |
| Builder: | 0.5-1.5 | g/L wash liquor |
| Amylase: | 0.5-1.5 | g/L g/L wash liquor |
| Protease: | 0.5-1.5 | g/L g/L wash liquor |
| Bleach system: | 0.5-2.5 | g/L wash liquor |
| Silicates: | 0.1-0.5 | g/L wash liquor |

The ADW composition can comprise:

| Lipase: | 0.01-2.0 gram per wash cycle (g/w), | |
|---|---|---|
| strong sequestering builder: | 16.2-162 | g/w, |
| non ionic surfactant: | 0.1-1.0 | g/w |
| Builder: | 0.5-2.0 | g/w |
| Amylase: | 0.01-2.0 | g/w |
| Protease: | 0.01-2.0 | g/w |
| Bleach system: | 0.5-3.0 | g/w |
| Silicates: | 0.0-0.5 | g/w |

In one embodiment the ADW composition comprises

| | | |
|---|---|---|
| Lipase: | 0.5-1.5 | g/w |
| strong sequestering builder: | 32.4-54 | g/w |
| non ionic surfactant: | 0.1-1.0 | g/w |
| Builder: | 0.5-1.5 | g/w |
| Amylase: | 0.5-1.5 | g/w |
| Protease: | 0.5-1.5 | g/w |
| Bleach system: | 0.5-2.5 | g/w |
| Silicates: | 0.1-0.5 | g/w |

The composition can further comprise one or more components selected from the group consisting of polymers, bleaching systems, bleach activators, bleach catalysts, silicates, dyestuff and metal care agents.

When the consumer is satisfied with the result of the automatic washing process with the present ADW detergent composition and with the fact that no unpleasant smell is released from the clean dishware or the interior of the dishwasher, the consumer do not tend to overdose the ADW detergent composition in order to improve the cleaning result. This has a positive influence on the local environment where the drained wash liquor is released.

The invention also concerns the use of an aqueous wash liquor comprising lipase for cleaning the interior of a washing machine, wherein the hardness of the wash liquor is below 3° dH. The lipase can be used for cleaning items in the interior of the dishwashing machine such as dishware baskets, nozzles, pumps, sump, filters, pipelines, drains and outlets. The cleaning may be carried out during a wash cycle for washing dishware.

The invention further concerns the use of an aqueous wash liquor comprising lipase for preventing or removing fatty acid precipitate during an automatic dishwashing method. The wash liquor should have a degree of hardness below 3° dH. The prevention of formation of fatty acid precipitate can be carried out simultaneously with and during a wash cycle for washing dishware.

The invention further concerns the use of a wash liquor comprising lipase for preventing or removing malodor in automated dishwashing. The malodor prevention/removal can be carried out simultaneously with and during a wash cycle for washing dishware.

For all the mentioned uses of lipases in ADW the wash liquor can comprise a strong sequestering builder.

The invention further concerns the use of aqueous wash liquor comprising lipase for preventing or removing limescale in an automatic dishwasher. The wash liquor should comprise one or more strong sequestering builders in addition to the lipase. The built-up of limescale can be prevented or removed from dishware baskets, nozzles, pumps, sump, filters, pipelines, drains, outlets and dishware. The prevention and/or removal of limescale can be carried out during a wash cycle for washing dishware.

The water in used in the wash liquor of all the mentioned uses can be distilled water, rain water or softened water. The wash liquor may have a degree of hardness below 2.9° dH, such as below 2.8° dH, below 2.7° dH, below 2.6° dH, below 2.5° dH, below 2.4° dH, below 2.3° dH, below 2.2° dH, below 2.1° dH, below 2.0° dH, below 1.9° dH, below 1.8° dH, below 1.7° dH, below 1.6° dH, below 1.5° dH, below 1.4° dH, below 1.3° dH, below 1.2° dH, below 1.1° dH, below 1.0° dH, below 0.9° dH, below 0.8° dH, below 0.7° dH, below 0.6° dH, below 0.5° dH, below 0.4° dH, below 0.3° dH, below 0.2° dH or below 0.1° dH.

The lipase can be comprised in the inventive ADW detergent composition. The temperature of the wash liquor when used in any of the above embodiments may be in the range of 10-70° C. For example the temperature of the wash liquor can be in the range of 15-60° C., in the range of 20-50° C., in the range of 25-50° C., in the range of 30-45° C. or in the range of 35-40° C.

The temperature may vary throughout the wash program One enzyme may be activated at one active temperature range and other enzymes may be activated at another active temperature range differing from the active temperature range of the first enzyme. The enzymes can be amylase, protease and lipase. . For example, one or more wash cycles may be carried out at a temperature of 32-38° C. and other wash cycles may be carried out at a temperature of 45-55° C. The advantage of this is that the single enzymes are allowed to work at their optimal temperature.

### Enzyme of the Present Invention

In one embodiment of the present invention, a lipase of the present invention may be added to a detergent composition in an amount corresponding to 0.001-200 mg of protein, such as 0.005-100 mg of protein, preferably 0.01-50 mg of protein, more preferably 0.05-20 mg of protein, even more preferably 0.1-10 mg of protein per liter of wash liquor.

The lipase of the ADW detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

### Surfactants

The dish washing composition can include at least one non-ionic surfactant. Suitable nonionic surfactants include, but are not limited to low-foaming nonionic (LFNI) surfactants. A LFNI surfactant is most typically used in an automatic dishwashing composition because of the improved water-sheeting action (especially from glassware) which they confer to the automatic dishwashing composition. They also may encompass non-silicone, phosphate or nonphosphate polymeric materials which are known to defoam food soils encountered in automatic dishwashing. The LFNI surfactant may have a relatively low cloud point and a high hydrophilic-lipophilic balance (HLB). Cloud points of 1% solutions in water are typically below about 32° C. and alternatively lower, e.g., 0° C., for optimum control of sudsing throughout a full range of water temperatures. If desired, a biodegradable LFNI surfactant having the above properties may be used.

A LFNI surfactant may include, but is not limited to: alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene-polyoxypropylene polymeric compounds that meet the requirements may include those based on ethylene glycol, propylene glycol, glycerol, trimethylolpropane and ethylenediamine, and mixtures thereof. Polymeric compounds made from a sequential ethoxylation and propoxylation of initiator compounds with a single reactive hydrogen atom, such as C12- is aliphatic alcohols, do not generally provide satisfactory suds control in Automatic dishwashing compositions. However, certain of the block polymer surfactant compounds designated as PLURONIC(R) and TETRONIC(R) by the BASF-Wyandotte Corp., Wyandotte, Mich., are suitable in Automatic dishwashing compositions. The LFNI surfactant can optionally include a propylene oxide in an amount up to about 15% by weight. Other LFNI surfactants can be prepared by the processes described in U.S. Pat. No. 4,223,163. The LFNI surfactant may also be derived from a straight chain fatty alcohol containing from about 16 to about 20 carbon atoms (C16-C20 alcohol), alternatively a Ci8 alcohol, condensed with an average of from about 6 to about 15 moles, or from about 7 to about 12 moles, and alternatively, from about 7 to about 9 moles of ethylene oxide per mole of alcohol. The ethoxylated nonionic surfactant so derived may have a narrow ethoxylate distribution relative to the average.

In certain embodiments, a LFNI surfactant having a cloud point below 30° C. may be present in an amount from about 0.01% to about 60%, or from about 0.5% to about 10% by weight, and alternatively, from about 1% to about 5% by weight of the composition

In preferred embodiments, the surfactant is a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and stability in product than single non-ionic surfactants. Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20. Preferably, the surfactant of formula I has at least about 10 carbon atoms in the terminal epoxide unit [CH₂CH(OH)R₂]. Suitable surfactants of formula I are Olin Corporation's POLY-TERGENT(R) SLF-18B nonionic surfactants, as described, for example, in WO 94/22800, published Oct. 13, 1994 by Olin Corporation.

Preferably non-ionic surfactants and/or system herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.). Amine oxides surfactants are also useful in the present invention as anti-redeposition surfactants include linear and branched compounds having the formula:

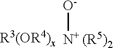

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide. Surfactants and especially non-ionic surfactants may be present in amounts from 0 to 10% by weight, preferably from 0.1% to 10%, and most preferably from 0.25% to 6%.

### Sulfonated Polymer

The polymer, if used, is used in any suitable amount from about 0.1% to about 20%, preferably from 1% to about 15%, more preferably from 2% to 10% by weight of the composition. Sulfonated/carboxylated polymers are particularly suitable for the compositions contained in the pouch of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

As noted herein, the sulfonated/carboxylated polymers may comprise (a) at least one structural unit derived from at least one carboxylic acid monomer having the general formula (I):

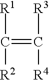

wherein R¹ to R⁴ are independently hydrogen, methyl, carboxylic acid group or CH₂COOH and wherein the carboxylic acid groups can be neutralized; (b) optionally, one or more structural units derived from at least one nonionic monomer having the general formula (II):

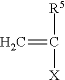

wherein R⁵ i is hydrogen, C₁ to C₆ alkyl, or C₁ to C₆ hydroxyalkyl, and X is either aromatic (with R⁵ being hydrogen or methyl when X is aromatic) or X is of the general formula (III):

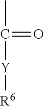

wherein R⁶ is (independently of R⁵) hydrogen, C₁ to C₆ alkyl, or C₁ to C₆ hydroxyalkyl, and Y is O or N; and at least one structural unit derived from at least one sulfonic acid monomer having the general formula (IV):

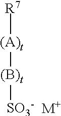

wherein R⁷ is a group comprising at least one sp² bond, A is O, N, P, S or an amido or ester linkage, B is a mono- or polycyclic aromatic group or an aliphatic group, each t is independently 0 or 1 , and M⁺ is a cation. In one aspect, R⁷ is a C₂ to C₆ alkene. In another aspect, R⁷ is ethene, butene or propene.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or [alpha]-methyl styrene.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer. 99

The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-1 -sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in ADW detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-op, triethanolamine (TEA, also known as 2,2′,2″-nitrilotriethan-1-ol), and (carboxymethyl)inulin (CMI), and combinations thereof.

The detergent composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1:9, and most preferably from 1:49 to 1:19. Preferably, the mixed salt is of sodium sulphate and sodium carbonate which has the general formula Na2S04.n.Na2CO3 wherein n is from 0.1 to 3, preferably n is from 0.3 to 1.0 and most preferably n is from 0.2 to 0.5.

Another suitable coating material providing in product stability, comprises sodium silicate of SiO2: Na20 ratio from 1.8:1 to 3.0:1, preferably L8:l to 2.4:1, and/or sodium metasilicate, preferably applied at a level of from 2% to 10%, (normally from 3% to 5%) of SiO2 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein. Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein. The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process. Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-[alpha]-naphthoic acid and magnesium monoperphthalate, (b) the aliphatic or substituted aliphatic peroxy acids, such as peroxylauric acid, peroxystearic acid, [epsilon]-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60 [deg.] C and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

### Bleach Catalyst

Bleach catalysts preferred for use herein include the manganese triazacyclononane, MnTACN and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes(U.S. Pat. No. 4810410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition. Oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases), can also be used according to the present invention to intensify the bleaching effect. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the stains, to ensure electron flow (mediators).

The detergent may contain 0-30% by weight, such as about 1% to about 20%, of a bleaching system. Any bleaching system known in the art for use in ADW detergents may be utilized. Suitable bleaching system components include bleaching catalysts, photobleaches, bleach activators, sources of hydrogen peroxide such as sodium percarbonate, sodium perborates and hydrogen peroxide-urea (1:1), preformed peracids and mixtures thereof. Suitable preformed peracids include, but are not limited to, peroxycarboxylic acids and salts, diperoxydicarboxylic acids, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable examples are tetraacetylethylenediamine (TAED), sodium 4-[(3,5,5-trimethylhexanoyl)oxy]benzene-1-sulfonate (ISONOBS), 4-(dodecanoyloxy)benzene-1-sulfonate (LOBS), 4-(decanoyloxy)benzene-1-sulfonate, 4-(decanoyloxy)benzoate (DOBS or DOBA), 4-(nonanoyloxy)benzene-1-sulfonate (NOBS), and/or those disclosed in WO98/17767. A particular family of bleach activators of interest was disclosed in EP624154 and particulary preferred in that family is acetyl triethyl citrate (ATC). ATC or a short chain triglyceride like triacetin has the advantage that it is environmentally friendly Furthermore acetyl triethyl citrate and triacetin have good hydrolytical stability in the product upon storage and are efficient bleach activators. Finally ATC is multifunctional, as the citrate released in the perhydrolysis reaction may function as a builder. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

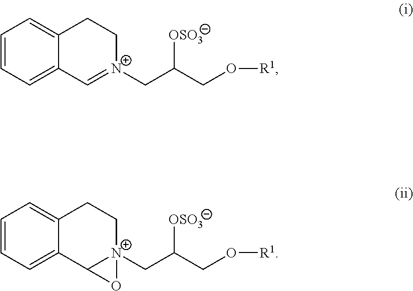

(iii) and mixtures thereof;

wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl. Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

Preferably the bleach component comprises a source of peracid in addition to bleach catalyst, particularly organic bleach catalyst. The source of peracid may be selected from (a) pre-formed peracid; (b) percarbonate, perborate or persulfate salt (hydrogen peroxide source) preferably in combination with a bleach activator; and (c) perhydrolase enzyme and an ester for forming peracid in situ in the presence of water in a ADW treatment step.

### Silicates

Preferred silicates are sodium silicates such as sodium disilicate, sodium metasilicate and crystalline phyllosilicates. Silicates if present are at a level of from about 1 to about 20%, preferably from about 5 to about 15% by weight of composition.

### Metal Care Agents

Metal care agents may prevent or reduce the tarnishing, corrosion or oxidation of metals, including aluminium, stainless steel and non-ferrous metals, such as silver and copper. Suitable examples include one or more of the following:

(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain Ci-C20-alkyl groups and hydroxyl, thio, phenyl or halogen such as fluorine, chlorine, bromine and iodine.

(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K̂TiF6, K̂ZrF6, CoSO4, Co(NOs)2 and Ce(NOs)3, zinc salts, for example zinc sulphate, hydrozincite or zinc acetate; (c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859.

Preferably the composition of the invention comprises from 0.1 to 5% by weight of the composition of a metal care agent, preferably the metal care agent is a zinc salt.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Enzymes

The ADW detergent composition may comprise one or more [additional] enzymes such as a protease, lipase, cutinase and an amylase. In general the properties of the selected enzyme(s) should be compatible with the selected detergent, (i.e., pH-optimum, compatibility with other enzymatic and non-enzymatic ingredients, etc.), and the enzyme(s) should be present in effective amounts.

### Proteases:

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN', subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN' numbering. More preferred the subtilase variants may comprise the mutations: S3T, V4I, S9R, A15T, K27R, *36D, V68A, N76D, N87S,R, *97E, A98S, S99G,D,A, S99AD,

S101G,M,R S103A, V1041,Y,N, S106A, G118V,R, H120D,N, N123S, S128L, P129Q, S130A, G160D, Y167A, R170S, A194P, G195E, V199M, V2051, L217D, N218D, M222S, A232V, K235L, Q236H, Q245R, N252K, T274A (using BPN' numbering).

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes NS), those sold under the tradename Maxatase®, Maxacal®, Maxapem®, Purafect®, Purafect Prime®, Preferenz™, Purafect MA®, Purafect Ox®, Purafect OxP®, Puramax®, Properase®, Effectenz™, FN2®, FN3®, FN4®, Excellase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

### Lipases and Cutinases:

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™; Lipolex™ and Lipoclean™ (Novozymes NS), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases:

Suitable amylases which can be used together with the ADW composition of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T491+G107A+H156Y+A181T+N190F+1201F+A209V+Q2645.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K wherein the variants are

C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ (from Novozymes NS), and Rapidase™, Purastar™/Effectenz™, Powerase and Preferenz S100 (from Genencor International Inc./DuPont).

The detergent enzyme(s) may be included in an ADW detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Adjunct Materials

Any detergent components known in the art for use in ADW detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in ADW detergents may be utilized. The choice of such ingredients is well within the skill of the artisan.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent , which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

The invention is further summarised in the following paragraphs:
1. An automated dishwashing method comprising the following steps:
   a. Exposing dishware to an aqueous wash liquor comprising at least one lipase and a strong sequestering builder;
   b. Completing at least one wash cycle; and
   c. Optionally rinsing and drying the dishware;
wherein the strong sequestering builder is a non-phosphorus builder.
2. A method according to paragraph 1, wherein the water in the wash liquor is distilled water, rain water or softened water.
3. A method according to any of the preceding paragraphs, wherein the wash liquor has a degree of hardness below 2.9° dH, such as below 2.8° dH, below 2.7° dH, below 2.6° dH, below 2.5° dH, below 2.4° dH, below 2.3° dH, below 2.2° dH, below 2.1° dH, below 2.0° dH, below 1.9° dH, below 1.8° dH, below 1.7° dH, below 1.6° dH, below 1.5° dH, below 1.4° dH, below 1.3° dH, below 1.2° dH, below 1.1° dH, below 1.0° dH, below 0.9° dH, below 0.8° dH, below 0.7° dH, below 0.6° dH, below 0.5° dH, below 0.4° dH, below 0.3° dH, below 0.2° dH or below 0.1° dH.
4. A method according to any of the preceding paragraphs, wherein the wash liquor comprises one or more surfactants.
5. A method according to any of the preceding paragraphs, wherein the surfactants are non-ionic surfactant.
6. A method according to any of the preceding paragraphs, wherein the non-ionic surfactants are selected from the group consisting of etholylated non-ionic surfactant, epoxy-capped poly(oxyalkylated) alcohols.
7. A method according to any of the preceding paragraphs, wherein the surfactant is not an alkyl polyglucoside.
8. A method according to any of the preceding paragraphs, wherein the wash liquor comprises at least one additional enzyme.
9. A method according to paragraph 8, wherein the wash liquor comprises amylase and/or protease.
10. A method according to any of the preceding paragraphs, wherein the strong sequestering builder is selected from the group consisting of EDTA, MGDA, NTA, IDS, GLDA and EDDS.
11. A method according to any of the preceding paragraphs, wherein concentration of the strong sequestering builder in the wash liquor may be above 3 gram of the strong sequestering builder/liter of wash liquor (g/L), such as in the range of 3-30 g/L, in the range of 4-30 g/L, in the range of 5-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 8-30 g/L, in the range of 9-30 g/L, in the range of 10-30 g/L, in the range of 15-30 g/L or in the range of 20-30 g/L.
12. A method according to any of the preceding paragraphs, wherein theconcentration of EDTA in the wash liquor may be above 3 gram EDTA/liter of wash liquor (g/L), such as in the range of 3-30 g/L, in the range of 4-30 g/L, in the range of 5-30 g/L, in the range of 6-30 g/L, in the range of 6-25 g/L, in the range of 6-20 g/L, in the range of 6-18 g/L, in the range of 6-16 g/L, in the range of 6-14 g/L, in the range of 6-12 g/L, in the range of 6-10 g/L, in the range of 7-30 g/L, in the range of 8-30 g/L, in the range of 9-30 g/L, in the range of 10-30 g/L, in the range of 15-30 g/L or in the range of 20-30 g/L.
13. A method according to any of the preceding paragraphs, wherein the dishwashing method comprises rinsing the dishware with water or water comprising a rinsing aid.
14. A method according to any of the preceding paragraphs, wherein the temperature of the wash liquor is in the range of 20-90° C.
15. A method according to any of the preceding paragraphs, wherein the temperature of the wash liquor is in the range of 20-70° C., in the range of 20-60° C., in the range of 20-55° C., in the range of 25-55° C., in the range of 30-55° C. or in the range of 45-55° C.
16. A method according to any of the preceding paragraphs, wherein the temperature of the wash liquor is 55° C.
17. A method according to any of the preceding paragraphs, wherein the temperature varies.
18. A method according to any of the preceding paragraphs, wherein the method comprises drying the dishware after completion of the wash cycle and optionally rinsing of the dishware.
19. A method according to any of the preceding paragraphs, wherein the lipase is of bacterial or fungal origin.
20. A method according to any of the preceding paragraphs, wherein the lipase is chemically modified or protein engineered.
21. A method according to any of the preceding paragraphs, wherein the lipase is derived from Thermomyces, e.g. from T. lanuginosus, cutinase from Humicola, e.g. H. insolens, strains of Pseudomonas, e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, Thermobifida fusca, Geobacillus stearothermophilus, Bacillus subtilis, Streptomyces griseus and S. pristinaespiralis.
22. A method according to any of the preceding paragraphs, wherein the lipase has at least 90%, such as at least 95%, sequence identity to SEQ ID NO: 1 or a variant thereof.
23. A method according to any of the preceding paragraphs, wherein the lipase is a variant of SEQ ID NO: 1 selected from the group consisting of:
a. A variant of SEQ ID NO: 1 comprising the following substitutions T231R and N233R;
b. A variant of SEQ ID NO: 1 comprising the following substitutions D27R, G38A, D96E, D111A, G163K, T231R, N233R, D254S and P256T;
c. A variant of SEQ ID NO: 1 comprising one of the following combinations of substitutions:
   i. G91A +D96G +T231R +N233R;
   ii. G91Q +T143A +E210Q +T231R +N233R +P250R;
   iii. G91Q +A150G +E210Q +T231R +N233R +P250R;
   iv. T37R +N39R +G91A +D96G +T231 R +N233R;
   v. G91A +D96G +G225R +T231 R +N233R;
   vi. G91Q +E210Q +T231R +N233R +P250R;
   vii. G91N +E210Q +T231R +N233R +P250R;
   viii. G91I +E210Q +T231R +N233R +P250R;
   ix. G91L +E210Q +T231R +N233R; or
   x. G91A +D96G +A150G +T231 R +N233R;
24. An automatic dishwashing detergent composition comprising at least one lipase and a strong sequestering builder, wherein the strong sequestering builder is a non-phosphorus builder.
25. A composition according to paragraph 27, wherein the composition further comprises one or more surfactants.
26. A composition according to any of the preceding composition paragraphs, wherein the surfactants are non-ionic surfactant.
27. A composition according to any of the preceding composition paragraphs, wherein the non-ionic surfactants are selected from the group consisting of etholylated non-ionic surfactant, epoxy-capped poly(oxyalkylated) alcohols.
28. A composition according to any of the preceding composition paragraphs, wherein the surfactant is not an alkyl polyglucoside.
29. A composition according to any of the preceding composition paragraphs, wherein the composition comprises at least one additional enzyme.
30. A composition according to paragraph 30, wherein the composition comprises amylase and/or protease.
31. A composition according to any of the preceding composition paragraphs, wherein the strong sequestering builder is selected from the group consisting of:
   EDTA, MGDA, NTA, IDS, GLDA and EDDS.
32. A composition according to any of the preceding composition paragraphs, wherein the concentration of the strong sequestering builder is above 16.2 gram of the strong sequestering builder/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.
33. A composition according to any of the preceding composition paragraphs, wherein the concentration of EDTA is above 16.2 gram EDTA/wash cycle (g/w), such as in the range of 16.2-162 g/w, in the range of 21.6-162 g/w, in the range of 27.0-162 g/w, in the range of 32.4-162 g/w, in the range of 32.4-135 g/w, in the range of 32.4-108 g/w, in the range of 32.4-97.2 g/w, in the range of 32.4-86.4 g/w, in the range of 32.4-75.6 g/w, in the range of 32.4-64.8 g/w or in the range of 32.4-54.0 g/w, in the range of 43.2-162 g/w, in the range of 48.6-162 g/w, in the range of 54-162 g/w, in the range of 81-162 g/w, in the range of 108-162 g/w, in the range of 32.4-54.0 g/w or in the range of 32.4-54.0 g/w. When washing with an automated dishwasher the detergent composition is released in main wash.
34. A composition according to any of the preceding composition paragraphs, wherein the composition is in the form of a powder, a bar, a homogenous tablet, a tablet having two or more layers, a pouch having one or more compartments, a regular or compact powder, a granule, a paste, a gel, or a regular, compact or concentrated liquid.
35. A composition according to any of the preceding composition paragraphs, wherein the composition is a regular, compact or concentrated liquid.
36. A composition according to any of the preceding composition paragraphs, wherein the lipase is of bacterial or fungal origin.
37. A composition according to any of the preceding composition paragraphs, wherein the lipase is chemically modified or protein engineered.
38. A composition according to any of the preceding composition paragraphs, wherein the lipase is derived from Thermomyces, e.g. from T. lanuginosus, cutinase from Humicola, e.g. H. insolens, strains of Pseudomonas, e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, Thermobifida fusca, Geobacillus stearothermophilus, Bacillus subtilis, Streptomyces griseus and S. pristinaespiralis.
39. A composition according to any of the preceding composition paragraphs, wherein the lipase has at least 90%, such as at least 95%, sequence identity to SEQ ID NO: 1 or a variant thereof.
40. A composition according to any of the preceding composition paragraphs, wherein the lipase is a variant of SEQ ID NO: 1 selected from the group consisting of:
   a. A variant of SEQ ID NO: 1 comprising the following substitutions T231R and N233R;
   b. A variant of SEQ ID NO: 1 comprising the following substitutions D27R, G38A, D96E, D111A, G163K, T231R, N233R, D254S and P256T;
   c. A variant of SEQ ID NO: 1 comprising one of the following combinations of substitutions:
      i. G91A +D96G +T231 R +N233R;
      ii. G91Q +T143A +E210Q +T231R +N233R +P250R;
      iii. G91Q +A150G +E210Q +T231R +N233R +P250R;
      iv. T37R +N39R +G91A +D96G +T231 R +N233R;
      v. G91A +D96G +G225R +T231 R +N233R;
      vi. G91Q +E210Q +T231R +N233R +P250R;
      vii. G91N +E210Q +T231R +N233R +P250R;
      viii. G91I +E210Q +T231R +N233R +P250R;
      ix. G91L +E210Q +T231R +N233R; or
      x. G91A +D96G +A150G +T231 R +N233R;
41. A composition according to any of the preceding composition paragraphs wherein the composition comprises:

| a. Lipase: | 0.01-2.0 gram per wash cycle (g/w) | |
|---|---|---|
| b. strong sequestering builder: | 1, 16.2-162 | g/w |
| c. non ionic surfactant: | 0.1-1.0 | g/w |
| d. Builder: | 0.5-2.0 | g/w |
| e. Amylase: | 0.01-2.0 | g/w |
| f. Protease: | 0.01-2.0 | g/w |
| g. Bleach system: | 0.5-3.0 | g/w |
| h. Silicates: | 0.0-0.5 | g/. |

42. A composition according to any of the preceding composition paragraphs, wherein the composition further comprises one or more components selected from the group consisting of polymers, bleaching systems, bleach activators, bleach catalysts, silicates, dyestuff and metal care agents.
43. A rinsing aid for use in an automatic dish washing method, wherein the rinsing aid is capable of lowering the pH below 4 during at least a period of a rinse cycle in an automated dishwashing process.
44. Rinsing aid according to paragraph 44, wherein the pH is lowered below pH 4 for at least 1 minute, such as at least 2 minutes, at least 3 minutes, at least 4 minutes, at least 5 minutes, at least 6 minutes or at least 7 minutes.
45. Rinsing aid according to any of paragraphs 44-45, wherein the pH is lowered below pH 4 during the complete rinse cycle.
46. Rinsing aid according to any of paragraphs 44-46, wherein the pH is lowered below pH 3.5, such as below pH 3, below pH 2.5 or below pH 2.
47. Rinsing aid according to any of paragraphs 44-47, wherein the composition further comprises a lipase and a strong sequestering builder.
48. Rinsing aid according to any of paragraphs 44-48, wherein the buffer agent is selected from the group consisting of citric acid or acetic acid or buffer mixtures like citric acid, acetic acid, potassium dihydrogen phosphate, boric acid, diethyl barbituric acid, Carmody buffer and Britton-Robinson buffer.
49. Rinsing aid according to any of paragraphs 44-49, wherein the rinsing aid is capable of lowering the pH below 4 during at least a period of the rinsing step.
50. Use of an aqueous wash liquor in ADW, wherein the wash liquor comprises a lipase and a non-phosphorus strong sequestering builder.
51. Use of the dishwashing composition according to paragraphs 24-42 for cleaning the interior of a washing machine.
52. Use according to any of paragraphs 50-51, for cleaning the interior of a washing machine.
53. Use according to any of the preceding use paragraphs, wherein dishware baskets, nozzles, pumps, sump, filters, pipelines, drains and outlets are cleaned.
54. Use according to any of the preceding use paragraphs for preventing and/or removing fatty acid precipitate during an automatic dishwashing method.
55. Use according to any of the preceding use paragraphs for preventing and/or removing malodor in automated dishwashing.
56. Use according to paragraph 56, wherein cleaning, prevention and/or removal of fatty acid precipitate and the malodor prevention and/or removal is carried out during a wash cycle for washing dishware.
57. Use according to any of the preceding use paragraphs for preventing and/or removing limescale in an automatic dishwasher, wherein the wash liquor further comprises one or more strong sequestering builders.
58. Use according to paragraph 58, wherein the limescale is prevented or removed from dishware baskets, nozzles, pumps, sump, filters, pipelines, drains, outlets and dishware.
59. Use according to any of paragraphs 58-59, wherein the prevention and/or removal of limescale is carried out during a wash cycle for washing dishware.
60. Use according to any of the preceding use paragraphs, wherein the water in the wash liquor is distilled water, rain water or softened water.
61. Use according to any of the preceding use paragraphs, wherein the wash liquor has a degree of hardness below 2.9° dH, such as below 2.8° dH, below 2.7° dH, below 2.6° dH, below 2.5° dH, below 2.4° dH, below 2.3° dH, below 2.2° dH, below 2.1° dH, below 2.0° dH, below 1.9° dH, below 1.8° dH, below 1.7° dH, below 1.6° dH, below 1.5° dH, below 1.4° dH, below 1.3° dH, below 1.2° dH, below 1.1° dH, below 1.0° dH, below 0.9° dH, below 0.8° dH, below 0.7° dH, below 0.6° dH, below 0.5° dH, below 0.4° dH, below 0.3° dH, below 0.2° dH or below 0.1° dH.
62. Use according to any of the preceding use paragraphs, wherein the lipase is comprised in the automatic dishwashing detergent composition of any of paragraphs 24-42.
63. Use according to any of the preceding use paragraphs, wherein the temperature of the wash liquor is in the range of 10-70° C.
64. Use according to any of the preceding use paragraphs, wherein the temperature of the wash liquor is in the range of 15-60° C., in the range of 20-50° C., in the range of 25-50° C., in the range of 30-45° C. or in the range of 35-40° C.
65. Use of an acidic rinse composition for cleaning dishware, wherein the acidic rinse composition lowers the pH of the rinsing water below pH 4.
66. Use according to paragraph 71, wherein the pH of the rinsing water is lowered to below pH 3.5, below pH 3, below pH 2.5 or below pH 2.

### Experimental Section

### Assays

### Determination of Waterhardness (° dH)

For water hardness determination, CDM210 conductivity meter (supplied by Radiometer Analytical) with CDC566T CELL (supplied by Radiometer Analytical) is used. The CDM210 Conductivity meter with the 4-pole cell CDC566T is used for measuring the conductivity in liquids.

Water, e.g., the wash liquor at room temperature, around 20-25° C. is placed in a beaker and the water hardness is measured by placing the CDC566T CELL in the water and measuring at <30 mS/cm. The conductivity is measured and the value given in Ω·m and the water hardness is calculated using standard curves at different water hardness.

Standard Curve of Conductivity vs. Water Hardness

| Water Hardness (° dH) | 0 | 3 | 4 | 6 | 9 | 15 | 20 |
|---|---|---|---|---|---|---|---|
| Conductivity (us/cm) | 1.4 | 142.0 | 186.7 | 275.3 | 412.2 | 673.4 | 878.6 |

### Wash Assay I

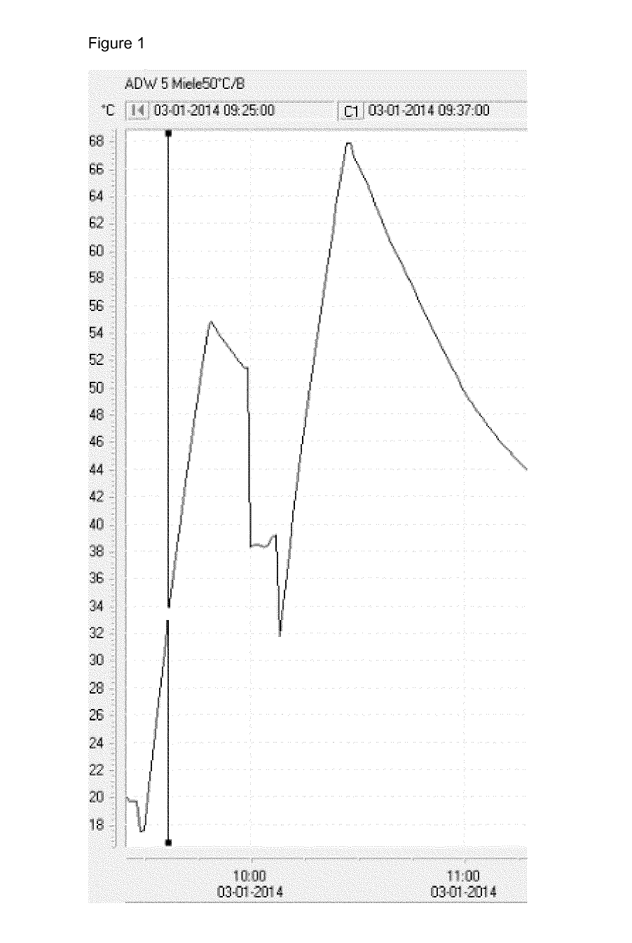

The lipase was tested using a full scale wash in a Miele G4300 SCU automatic dishwashing machine. Washing program used was Universal 50° C., using tap water with water hardness 20° dH with a total washing time of about 90 minutes. The washing programme comprises a rinsing cycle, a washing cycle followed by two rinsing cycles. FIG. 1 shows the the temperature in the automatic dish wash machine versus the washing time. The temperature profile was measured for the Universal 50° C. programme during one the washes performed during the experiment. From the figure it is seen that in the beginning of the wash programme, cold water is coming in and decreasing the temperature somewhat and after that the heat up is starting and reaching up to about 50-54° C. The main wash at 50-54° C. continues for about 20-25 minutes after that the water is drained and the temperature decreases. Then clean tap water is supplied and a small temperature increase is seen. This corresponds to the first rinse cycle. After the first rinse cycle the rinse water is drained and clean tap water is supplied. The water is heated to about 68 C. The rinse water is drained after a few minutes, ending the second rinse cycle. The temperature in the drying phase slowly decreases. The wash cycle is finished after a total of 90 minutes.

For rinsing tap water with water hardness 20° dH was used. The amount of water in the main wash was 5.4 liter.

The commercially available ADW detergent “Finish Calgonit Quantum Regular” (Reckitt Benckiser) was used, see composition below. In addition 50 grams of soil was added into the machine before start. The soil was prepared as shown in appendix 3 on page 44 of SÖFW-Journal, volume 132, No 8-2006.

The wash was completed without dishware in the dishwashing machine.

### Detergent Compositions

### Composition of Finish Calgonit Quantum Regular

Detergent composition of Finish Calgonit Quantum Regular (http://www.rbeuroinfo.com/, Germany, bought in Germany in 2013): Pentasodium triphosphate, Sodium carbonate peroxide, Polyvinylalcohol, 2-propenoic acid (homopolymer, sodium salt, sulfonated), Aqua, Tetrasodium etidronate, Fatty alcohol alkoxylate, Sodium carbonate, TAED, PEG-800, Sorbitol, Propylene glycol, Sodium sulphate, Trimethylolpropane, Sucrose, Oryza sativa starch, Tetrasodium pyrophosphate, Sodium chloride, Protease, 2-propenoic acid (homopolymer, sodium salt) Dimethicone, Methyl-1H-benzotriazole, PEG-130-PEG-150, Manganese-II-oxalate, Perfume, Colorant, Amylase, Stearamide, Soap, Petroleum distillates, Steareth-21, Titanium dioxide, Cellulose, Propylene glycol and Kaolin (the ingredients are listed in descending order).

1 tablet of Finish Calgonit Quantum Regular weighs 20 grams.

### Composition of Various Detergent Compositions

| Detergent | Composition | Composition | Composition | Composition |
|---|---|---|---|---|
| component | 1 g/L | 2 g/L | 3 g/L | 4 g/L |
| MGDA | 1.68 | 0.77 | 1.65 | — |
| Sodium | 0.67 | 0.67 | 0.66 | 3.09 |
| Carbonate | | | | |
| Sodium | 0.38 | 0.38 | 0.33 | 1.82 |
| percarbonate | | | | |
| Sodium | 0.21 | 0.17 | 0.17 | 0.91 |
| disilicate | | | | |
| Sodium | 1.11 | 1.11 | 1.06 | 6.55 |
| sulphate | | | | |
| Acusol 588 | 0.45 | 0.45 | — | 0.91 |
| (liq) | | | | |
| TAED/MnOx | 0.10 | 0.10 | 0.15 | 0.36 |
| Non ionic | 0.17 | 0.17 | 0.17 | |
| surfactant | | | | |
| Sokalan ® | — | — | 0.42 | |
| CP5 (liq) | | | | |
| Surfac 23-6.5 | | | | 0.91 |
| Sodium Citrate | | | | 3.64 |

### Assay for Detecting Malodor

After wash, the dishwashing machine is opened, and a trained test person detects by sniffing if a malodor is detected. The odour detection scoring is; yes odour detected or no, no odour detected.

### Assay for Determining the Presence of Fatty Acid Precipitate.

When the tableware is dry after the completion of a wash, the interior of the dishwashing machine is evaluated by a trained test person. The test person looks at the interior of the washing machine(walls, baskets and filter) and the items in the dishwashing machine (such as plates, forks, knives, spoons or kitchen utensils) to determine if fatty acid precipitate is present. The test person determines the presence of fatty acid precipitate according to the below mentioned score.

| Score | Description |
|---|---|
| No precipitation | Dishware and interior of dishwashing |
| | machine is more or less free of fattyacid |
| | precipitate. |
| Precipitation | Dishware and interior of dishwashing |
| | machine has a partial or full layer of fatty acid |
| | precipitate. |

### EXAMPLES

### Example 1

Wash assay I was used to test the effect of using a lipase in ADW at various degrees of water hardness. The water hardness of the water used for washing was adjusted to be 0° dH, 3° dH, 6° dH, 9° dH and 20° dH. The lipase used was T231 R+N233R variant of SEQ ID NO: 1.

1 tablet of Finish Calgonit Quantum Regular was added to the soap dispenser together with 0.85 gram of the lipase. The presence of malodor was detected as described in the assay for detecting malodor and the presence of fatty acid precipitate was evaluated as described in the assay for determining the presence of fatty acid precipitate.

The experiment showed that a for water hardness at 3° dH or below no malodor and no fatty acid precipitate was observed. At water hardness at 6° dH or above malodor and fatty acid precipitate was observed.

### Results:

| Water | Presence of fatty | Presence |
|---|---|---|
| hardness ° dH | acid precipitate | of malodor |
| 0 | No | No |
| 3 | No | No |
| 6 | Yes | Yes |
| 9 | Yes | Yes |
| 20 | Yes | Yes |

### Example 2

Wash assay I was used to test the effect of using a lipase in ADW and having a low pH in the second rinse cycle. The lipase used was T231 R+N233R variant of SEQ ID NO: 1.

Two ADW washes were carried out in order to compare the effect of rinsing at low pH. For both washes the water hardness was 20° dH and 1 tablet of Finish Calgonit Quantum Regular was added to the soap dispenser together with 0.85 gram of lipase. In one wash the washing program used water (20° dH) for rinsing in both rinse cycles. In the second wash water (20° dH) was used in the first rinse cycle and 15 ml 4 M HCI was added into the automatic dish wash machine in the second rinse cycle.

The presence of malodor was detected as described in the assay for detecting malodor and the presence of fatty acid precipitate was evaluated as described in the assay for determining the presence of fatty acid precipitate.

### Results:

| | Presence of fatty | Presence |
|---|---|---|
| Rinse cycle | acid precipitate | of malodor |
| Water | Yes | Yes |
| 15 ml 4M HCl added to | No | No |
| second rinse cycle | | |

### Example 3

Wash assay I was used to test the effect of using a lipase in ADW with various amounts of a strong sequestering builder (EDTA). The lipase used was T231R+N233R variant of SEQ ID NO: 1.

1 tablet of Finish Calgonit Quantum Regular was added to the soap dispenser together with 0.85 gram of lipase and 0, 2, 10 or 20 grams of EDTA/wash.

The presence of malodor was detected as described in the assay for detecting malodor and the presence of fatty acid precipitate was evaluated as described in the assay for determining the presence of fatty acid precipitate.

### Results:

| Grams of | Presence of fatty | Presence |
|---|---|---|
| EDTA/wash | acid precipitate | of malodor |
| 0 | Yes | Yes |
| 2 | Yes | Yes |
| 10 | No | No |
| 20 | No | No |

### Example 4

Wash assay I was used to test the effect of using different lipases in ADW at various degrees of water hardness. The water hardness of the water used for washing was adjusted to be 0° dH, 1° dH, 2° dH, 3° dH 6° dH 9° dH and 20° dH. The lipase used were T231R+N233R variant of SEQ ID NO: 1, N33Q+G91Q+E210Q+T231R+N233R+I255A variant of SEQ ID NO: 1 and D27R+G38A+D96E+D111A+G163K+T231R+N233R+D254S+P256T variant of SEQ ID NO: 1.

18.2 gram powder model ADW detergent, composition 4 described earlier, was added to the Miele machine together with 0.85 gram of the lipase variants and 0.51 gram of the protease of SEQ ID NO: 2 and 0.136 gram of the amylase of SEQ ID NO: 3. The presence of fatty acid precipitate was evaluated as described in the assay for determining the presence of fatty acid precipitate.

The experiment showed that a for water hardness at 2-3° dH or below no malodor and no fatty acid precipitate was observed. At water hardness at 6° dH or above malodor and fatty acid precipitate was observed.

Results:

| | Presence of fatty acid precipitate | | |
|---|---|---|---|
| | T231R + N233R | | |
| Water | variant of | Lipex Evity | Lipex Evity |
| hardness ° dH | SEQ ID NO: 1 | 105T | 100L |
| 0 | No | No | No |
| 1 | No | No | No |
| 2 | Yes | No | No |
| 3 | Yes | Yes | Yes |
| 6 | Yes | Not evaluated | Not evaluated |
| 9 | Yes | Not evaluated | Not evaluated |

### Example 5

The present example determines the amount of Strong sequestering builder needed to reduce the water hardness from about 20° dH down to about 3 dH.

The Thermo scientific total hardness method is used for determination of total Hardness in water by the use of Gallery analyzers.

Method: Colorimetric method based on calmagite.

### Principle of the Procedure:

The magnesium EDTA exchanges magnesium on an equivalent basis for any calcium and/or other cations to form a more stable EDTA chelate than magnesium. The free magnesium reacts with calmagite at a pH of 10 to give a red-violet complex. Wavelength 620 nm is used for measurement.

Reagent Compositions:
R1 Magnesium EDTA
R2 Buffer solution, pH 10
R3 Calmagite

### Results

In order to be able to reduce the water hardness from about 20° dH to 3° dH, a certain amount of strong sequestering builder is needed. The Colorimetric method based on calmagite, as described above was used. The strong sequestering builder MGDA was tested. The amount needed was 6 gram MGDA/L to reduce the water hardness from 20° dH to 3° dH.

Sodium citrate was also evaluated but within the evaluated amount added it was not possible to reduce the water hardness from 20° dH down to 3 dH. With about 6 g/L sodium citrate added, the water hardness was only reduced from 20° dH down to 18.1° dH.

1-15. (canceled)

16. An automated dishwashing method comprising the following steps:
(a) exposing dishware to an aqueous wash liquor comprising at least one lipase and a strong sequestering builder;
(b) completing at least one wash cycle; and
wherein the strong sequestering builder is a non-phosphorus builder.

17. The method of claim 16, further comprising rinsing and drying the dishware;

18. The method of claim 16, wherein the wash liquor comprises one or more surfactants, and at least one additional enzyme.

19. The method of claim 16, wherein the strong sequestering builder is selected from the group consisting of ethylenediaminetetraacetic acid (EDTA), methylglycinediacetic acid (MGDA), Nitrilotriacetic acid (NTA), iminodisuccinic acid (IDS), ethylenediaminedisuccinic acid (EDDS), and L-glutamic acid N,N-diacetic acid tetra sodium salt (GLDA).

20. The method of claim 16, wherein the concentration of the strong sequestering builder in the wash liquor may be above 3 gram of the strong sequestering builder/liter of wash liquor (g/L).

21. The method of claim 16, wherein the lipase has at least 90% sequence identity to SEQ ID NO: 1.

22. An automatic dishwashing detergent composition comprising at least one lipase and a strong sequestering builder, wherein the strong sequestering builder is a non-phosphorus builder.

23. The composition of claim 22, wherein the composition further comprises one or more surfactants.

24. The composition of claim 22, wherein the composition comprises at least one additional enzyme.

25. The composition of claim 22, wherein the strong sequestering builder is selected from the group consisting of ethylenediaminetetraacetic acid (EDTA), methylglycinediacetic acid (MGDA), Nitrilotriacetic acid (NTA), iminodisuccinic acid (IDS), ethylenediaminedisuccinic acid (EDDS), and L-glutamic acid N,N-diacetic acid tetra sodium salt (GLDA).

26. The composition of claim 22, wherein the concentration of the strong sequestering builder is above 32.4 gram of the strong sequestering builder/wash cycle (g/w).

27. The composition of claim 22, wherein the lipase has at least 90%, such as at least 95%, sequence identity to SEQ ID NO: 1 or a variant thereof.

28. A rinsing aid for use in an automatic dishwashing method, wherein the rinsing aid is capable of lowering the pH below 4 during at least a period of a rinse cycle in an automated dishwashing process.

29. A method of cleaning the interior of a washing machine, comprising treating the interior with the composition of claims 22.


SEQUENCE LISTING (3 sequences)

SEQ ID NO: 1 - protein, 269 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 2 - protein, 269 aa, bacillus clausii
AQSVPWGIRRVQAPTAHNRGLTGSGVKVAVLDTGISTHPDLNIRGGASFVPGEPSTQDENGHGTHAAGTIAALNNSIGVLGVAPSAELYAVKVLGSGGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLDGTSMATPHVAGAAALVKQKNPSWSNVRIRNHLKNTATSLGSTNLYGSGLVNAEAATR

SEQ ID NO: 3 - protein, 483 aa, Artificial Sequence
  protein
HHNGTNGTLMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRANTHSNFKWRWYHFDGVDWDQSRKLNNRIYKFRTKAWDWEVDTEFGNYDYLLYADIDMDHPEVVNELRNWGVWYTNTLGLDGFRIDAVKHIKYSFTRDWINHVRSAIGKNMFAVAEFWKNDLGAIENYLNKTNWNHSVFDVPLHFNLYYASKSGGNYDMRQIFNGTVVQKHPTHAVTFVDNHDSQPEESLESFVREWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK